(19) United States
(12) Patent Application Publication
(10) Pub. No.: US 2011/0320142 A1
(43) Pub. Date: Dec. 29, 2011

(54) TEMPERATURE INDEPENDENT PRESSURE SENSOR AND ASSOCIATED METHODS THEREOF

(75) Inventors: Cheryl Margaret Surman, Guilderland, NY (US); Radislav Alexandrovich Potyrailo, Niskayuna, NY (US); William Guy Morris, Rexford, NY (US)

(73) Assignee: GENERAL ELECTRIC COMPANY, SCHENECTADY, NY (US)

(21) Appl. No.: 12/824,436

(22) Filed: Jun. 28, 2010

(51) Int. Cl. G01L 9/10; G06F 19/00

(52) U.S. Cl. 702/50; 73/728; 977/742; 977/773; 977/953

(57) ABSTRACT

A temperature independent pressure sensor for selectively determining pressure is provided. The sensor comprises a resonance sensor circuit, a pressure sensitive component disposed on the sensor circuit, and an electromagnetic field modulator. A temperature independent pressure sensor system comprises a resonance sensor circuit, a pressure sensitive component disposed on the sensor circuit, an electromagnetic field modulator, and a processor that generates a multivariate analysis of sensor response pattern that is based on a change in an environmental pressure of the sensor system. A method of detecting a pressure response pattern in a temperature independent manner is also provided.

### FIELD

The invention relates to sensors and methods for detecting pressure, and more particularly to sensors and methods for detecting pressure independent from temperature.

### BACKGROUND

Radio frequency identification (RFID) tags are applicable for tracking various assets. Examples of applications of RFID tags include product authentication, ticketing, access control, lifetime identification of various items, specimen identification, baggage tracking, and many others. RFID tags are desirable for their small size and low cost.

A resonance-based component, such as an RFID tag, may be incorporated into sensors to detect chemical, biological or physical species and to determine environmental conditions such as temperature, pressure, humidity, or any other condition. Resonance-based sensing systems are also used in wireless sensing applications such as temperature sensors. Resonance-based sensors may also be adapted for chemical identification of multiple analytes and quantitation of the sensor response. By applying a sensing material onto the resonance antenna of an RFID sensor and measuring a complex impedance of the resonance antenna, it is possible to correlate the impedance response to the chemical properties of the analyte of interest.

Resonance-based sensors may be used, for example, in pharmaceutical processes or for research purposes. The sensors may be used to monitor the progression of a reaction, or to indicate any change in environmental conditions. Such resonance-based sensors may be embedded into various process components, such as bioreactors, mixers, product transfer lines, connectors, filters, separation columns, centrifugation systems, storage containers, and others to monitor the progression of, or change in, the process or reaction. These small, inexpensive disposable RFID-based sensor systems are ideally suited for in-line manufacturing monitoring and control.

Although resonance-based pressure sensors may be used to correlate a response signal with a change in pressure, such response signals may be deleteriously affected by other, interfering signals, thereby generating signal artifacts. The signal artifacts may also include unwanted signal responses, for example, responses generated from a change in temperature, while measuring a change in pressure.

Therefore, it is desirable to have a resonance-based temperature-independent pressure sensor, which can detect pressure, independent from temperature.

### BRIEF DESCRIPTION

The invention relates to resonance-based sensors, and associated sensor systems that are capable of sensing pressure independent from temperature, and methods for making and using the sensors. The use of these sensors or sensor systems resolve the problems associated with the measurement of pressure in a variable temperature environment.

In one embodiment, a resonance circuit-based temperature independent pressure sensor comprises a resonance sensor circuit, a pressure sensitive component disposed on the resonance sensor circuit, and an electromagnetic field (EMF) modulator. The EMF modulator is operatively coupled to the pressure sensitive component to at least partially modulate an electromagnetic field generated by the sensor circuit.

In another embodiment, a resonance circuit-based temperature independent pressure sensor system comprises a resonant sensor circuit; a pressure sensitive component disposed on the resonance sensor circuit, and an EMF modulator, and a processor. The EMF modulator is operatively coupled to the pressure sensitive component to at least partially modulate an EMF generated by the sensor circuit to produce a sensor response pattern. The processor generates a multivariate analysis of the sensor response pattern that is based, at least in part, on the sensor response pattern.

In one example of the methods of the invention, the method of measuring temperature independent pressure change of a sample comprises collecting impedance data using a sensor comprising a resonance sensor circuit, a pressure sensitive component and an EMF modulator, applying a multivariate analysis to a plurality of resonance parameters, at least two of which are based on the collected impedance data; and quantifying any change in pressure independent of a change in temperature based at least in part on the multivariate analysis.

### DRAWINGS

These and other features, aspects, and advantages of the present invention will become better understood when the following detailed description is read with reference to the accompanying drawings in which like characters represent like parts throughout the drawings, wherein:

FIGS. 1A and 1B are cross-sectional views of two non-limiting embodiments of resonance-based sensors of the invention.

FIG. 2 is a schematic drawing of an example of a system comprising a resonance-based sensor of the invention.

FIG. 3 is a flow diagram of an example of a method for making a resonance-based sensor of the invention.

FIG. 4 is a flow diagram of an example of a method for using a resonance-based sensor of the invention to measure pressure independent from temperature.

FIG. 5A is a graph showing a sensor response pattern of a change in pressure generated by an embodiment of a sensor of the invention that was subjected to two different pressure ranges and three different temperature ranges.

FIG. 5B is a graph showing the error distribution generated, using a sensor of the invention that was subjected to two different pressure ranges and three different temperature ranges.

FIG. 6A is a graph of an example of a multivariate response of resonance-based sensor of the invention, using principal components analysis (PCA) that was subjected to four different pressure ranges and three different temperature ranges.

FIG. 6B is a graph of a sensor response pattern generated by a resonance-based sensor of the invention, which was subjected to four different pressure ranges and three different temperature ranges.

FIG. 6C is a graph showing the error distribution generated using a resonance-based sensor of the invention that was subjected to four different pressure ranges and three different temperature ranges.

These and other features, aspects, and advantages of the present invention will become better understood when the following detailed description is read with reference to the accompanying drawings in which like characters represent like parts throughout the drawings, wherein:

### DETAILED DESCRIPTION

One or more of the embodiments of the resonance circuit-based temperature independent pressure sensor of the invention are adapted to measure pressure in a variable temperature environment independent from temperature variations that take place in the system during the pressure measurements. In one or more of the embodiments, the sensor comprises a resonance sensor circuit, a pressure sensitive component disposed on the resonance sensor circuit, and an EMF modulator. In some embodiments, the resonance circuit based temperature independent pressure sensor may be used in a sensor system.

To more clearly and concisely describe and point out the subject matter of the claimed invention, the following definitions are provided for specific terms, which are used in the following description and the appended claims. Throughout the specification, use of specific terms should be considered as non-limiting examples.

As used herein, ‘multivariate analysis’ refers to an analysis of signals where a single sensor produces multiple response signals. The multiple response signals from the multivariate sensor may be analyzed using multivariate analysis tools to construct response patterns of exposures to different environmental conditions, such as, pressure, or temperature.

As used herein, ‘disposed on’ refers to an arrangement where either a first surface is in direct physical contact with a second surface, or one or more intervening layers may be present between the first and the second surfaces and the surfaces are associated with each other by an indirect contact. For example, the first surface may be a surface on an RFID tag, and the second surface may be a surface of a pressure sensitive component.

As used herein, ‘detection medium’ refers to a medium for which the pressure is to be measured. For example, in a bioprocess component, the detection medium may be a liquid or a gas.

As used herein, ‘single use component’ refers to a manufacturing equipment or a monitoring equipment, which may be disposed of after use or may be reconditioned for reuse.

In one embodiment, the resonance sensor circuit is an inductor-capacitor-resistor (LCR) circuit. The sensor comprises an LCR circuit with a resonance frequency response provided by the impedance (Z) of the circuit. Parameters, such as resistance (R), capacitance (C), inductance (L) and frequency (f), may be used to determine the impedance (Z) of a circuit or a circuit part.

In some embodiments, the resonance sensor circuit comprises an RFID circuit. In one embodiment, the RFID circuit comprises an RFID tag. The RFID tag has an associated digital ID. The RFID tag may comprise an antenna, a capacitor, and an integrated circuit (IC) memory chip. The RFID tag may be a transponder. The RFID tag can also have no associated digital ID. In one embodiment, a pair of electrodes may be disposed on the RFID tag and may be coupled to the antenna but not to the IC memory chip. In one embodiment, a pair of electrodes may be disposed on the RFID tag and may be coupled to the IC memory chip. In another embodiment, a portion of the antenna may be configured to act as a pair of electrodes. Non-limiting examples of electrodes may include inter-digitated electrodes, or electrode coils.

The RFID tag may be a commercially available RFID tag. The commercially available RFID tag may operate at frequencies in a range from about 100 kHz to about 2.4 GHz, or up to about 20 GHz. The RFID tag may be a passive RFID tag, a semi-passive RFID tag, or an active RFID tag. The passive RFID tag does not require a power source (for example, a battery) for operation, while the semi-passive or active RFID tag needs a power source.

In one embodiment, the RFID tag may comprise an associated memory chip. In another embodiment, the tag may not comprise an associated memory chip. The memory chip of the RFID tag may be fabricated using integrated circuit fabrication processes, such as thermal diffusion, or high-energy ion-implantation, and organic electronic fabrication processes.

The RFID tag may produce detectable electrical signals. Non-limiting examples of detectable electrical signals produced by the RFID tag may include a change in resistance, a change in capacitance, a change in impedance, a change in reflected signal, a change in scattered signal, a change in absorbed signal, or a combination thereof. The frequency response of the antenna circuit of the RFID tag may be measured as the impedance having real and imaginary parts. In certain embodiments, a sensing film or a protecting film may be disposed on the RFID tag and the impedance may be measured as a function of the environment in proximity to the sensor.

An impedance response may be generated in resonance sensor circuit due to a change in an environmental pressure that is affecting the sensor. The resonance sensor circuit may affect the impedance response, which is measurably altered on variation of one or more properties of the pressure sensitive component due to a change in environmental pressure. In one embodiment, the detectable electrical signals are representative of the change in the environmental pressure.

In some embodiments, when the pressure sensitive component interacts with the EMF of the electrodes, a change in dimension of the pressure sensitive component produces detectable sensor response. The pressure sensitive component may be chosen such that the permittivity or dielectric constant of the pressure sensitive component is substantially different from that of the detection medium (e.g., fluid medium). The dielectric constant of the pressure sensitive component may be either less or more than the dielectric constant of the detection medium. The difference in the dielectric constants of the pressure sensitive component and the detection medium enhances the electrical signal produced by the sensor. In one example, the dielectric constant of the pressure sensitive component may be less than about 10 times the dielectric constant of a detection medium. In other example, the dielectric constant of the pressure sensitive component may be more than about 10 times the dielectric constant of the detection medium.

The pressure sensitive component may comprise one or more flexible membranes, diaphragms, mechanical springs, thin sheets, thin films, fibers, particles, meshes or webs. The pressure sensitive thin film may include, but is not limited to, a sol-gel film, a composite film, a nanocomposite film, a metal nanoparticle hydrogen film, a silicon film, or other polymeric films or foams. An example of a composite film is a carbon black-polyisobutylene film, an example of a nanocomposite film is carbon nanotube-Nafion® film, an example of a metal nanoparticle hydrogel film is a gold nanoparticle-hydrogel film, an example of a silicon film is a polycrystalline silicon film, or an example of polymeric foam is polyethylene foam. The pressure sensitive fiber may include but is not limited to, an electrospun polymer nanofiber, an electrospun inorganic nanofiber, or an electrospun composite nanofiber.

Non-limiting examples of the structure of the pressure sensitive component may be selected from spherical-shaped, dome-shaped, cubical-shaped, flat sheet, or a combination thereof. The pressure sensitive component may be a porous or a non-porous unit. The pressure sensitive component may be selectively permeable to a fluid. In one embodiment, the pressure sensitive component is a closed cell foam, such as a cross-linked closed cell polyolefin foam.

The ideal material for pressure sensitive component may be determined by establishing a dynamic range of the sensor response to EMF modulating material (e.g., metal) proximity, wherein the dynamic range is the range of operation of the sensor. A dynamic range is determined for the selected operating range of the sensor, which is in a range from about 10 to 40 psi, and the desired modulus of the pressure sensitive component may be calculated for the amount of pressure sensitive material being displaced or compressed. For example, the modulus of 120,000 Pa was calculated based on mechanical load (0-15 psi applied force) needed to achieve a desired displacement of 1 mm.

In some embodiments, the pressure sensitive component may comprise one or more of an organic, an inorganic, a biological, a composite, or a nanocomposite material that changes the dielectric property of the pressure sensitive component, based on the change in the environmental pressure. The material of the pressure sensitive component may be selected from a metal, a metal composite, a polymer, a plastic, a ceramic, a foam, a dielectric material, or a combination thereof. More specifically, the material may be selected from silicone based organic polymer, such as, polydimethylsiloxane (PDMS), or silicone gel. The pressure sensitive component may include, but is not limited to, a hydrogel such as poly(2-hydroxyethyl methacrylate), a sulfonated polymer such as Nafion®, or an adhesive polymer such as silicone adhesive.

Sensitivity of the pressure sensitive component may vary with a thickness, a flexibility, a permeability, or an elasticity of the pressure sensitive component. A thickness range of the pressure sensitive component may be dependent on coil spacing and the penetration depth of the EMF. A thickness range of the pressure sensitive component can range from about 10⁻⁵ mm to 10² mm. For example, the sensitivity may change with thickness of a pressure sensitive polymeric component. Sensitivity of the pressure sensitive component may further vary with material property of the component. A variation in Young's modulus of a material reflects a variation in elasticity of the material that results in a change in the sensitivity. For example, the implementation of a material having a relatively high Young's modulus may result in a less sensitive pressure sensor having relatively less elasticity. In contrast, the implementation of a material having a relatively low Young's modulus may result a more sensitive pressure sensor having relatively high elasticity. Non-limiting examples of Young's modulus of different materials, which may be used for the pressure sensor are shown in Table 1.

TABLE 1
Examples of Young's Modulus of different materials,
which may be used for the pressure sensor.

| Material | Young's Modulus (MPa) |
|---|---|
| Polybutadiene elastomer | 1.6 |
| Polyurethane elastomer | 25 |
| Polyamide (nylon) | 3000 |

The pressure sensitive component is disposed on the resonance sensor circuit. In one embodiment, the pressure sensitive component may be directly deposited on the sensor circuit. In an alternative embodiment, the pressure sensitive component may be deposited on a separate substrate, and the substrate may further be disposed on the sensor circuit. In some embodiments, one or more intervening layers may be present between the pressure sensitive component and the sensor circuit. A plurality of pressure sensitive components may be used in the sensor. In one embodiment, the plurality of pressure sensitive components may be of similar types. In another embodiment, the plurality of pressure sensitive components may be of different types, which may be combined together.

In one embodiment, the EMF of the sensor may be affected by the dielectric property of the pressure sensitive component. The EMF may be generated in the sensor antenna, and may extend out from the plane of the sensor. In one example, the efficiency of the radiation of the antenna may be modified using EMF modulator. In some embodiments, the pressure sensitive component may be impregnated with an electrically conductive material that functions as an EMF modulator. The electrically conductive material may be selected from carbon black particles, carbon nanotubes, graphene sheet, metal nanoparticles, metal microparticles, or combinations thereof. The electrically conductive material may be dispersed in a pressure sensitive component (such as a dielectric polymeric film with a relatively low Young's modulus). The concentration of the dispersed conductive material may be in a range from about 0.01% to 20% by volume of the final volume of the pressure sensitive component. The electrical conductivity of the pressure sensitive component is relatively low before applying a pressure to the pressure sensitive component, as compared to the electrical conductivity of the pressure sensitive component after applying a pressure to the pressure sensitive component. The EMF of a sensor may be modulated by an EMF modulator. In one embodiment, the EMF modulator is configured to absorb EMF. In another embodiment, the EMF modulator is configured to reflect EMF.

The EMF modulator may comprise one or more layers. The layers may be continuous, discrete, or patterned. In one embodiment, the EMF modulator may comprise two or more layers stacked together comprising the same material. In an alternate embodiment, two or more layers may comprise different materials. In the presence of the EMF modulator on the pressure sensitive component, the pressure-induced dimensional changes of the pressure sensitive component may affect the impedance of the antenna circuit. The EMF modulator may comprise a plurality of unit cells disposed at a predetermined distance. The unit cell may be generated by forming a conductive pattern on a dielectric substrate.

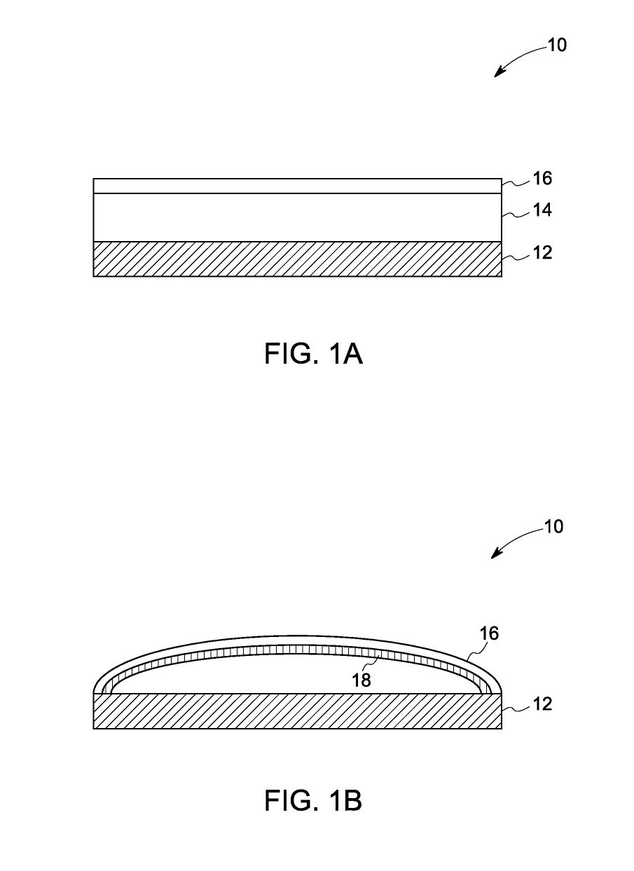

In one embodiment, when the EMF modulator is configured to absorb EMF (FIG. 1A), the EMF modulator is operatively coupled to the pressure sensitive component to at least partially absorb an EMF generated by the sensor circuit. The absorption of EMF may be different depending on the pressure applied to the pressure sensitive component. The difference originates from a change in gaps (or gap) between the conducting particles dispersed in the pressure sensitive component. The gaps between the conducting particles dispersed in the pressure sensitive component are relatively large in absence of applied pressure. The presence of large gaps between the conducting particles dispersed in the pressure sensitive component will generally result in a pressure sensitive component that is less conductive. The gaps between the conducting particles dispersed in the pressure sensitive component are relatively small in the presence of applied pressure. The presence of small gaps between the conducting particles dispersed in the pressure sensitive component will generally result in a pressure sensitive component that is more conductive. A more conductive pressure sensitive component will absorb EMF and will change the resonance properties of the sensor circuit. The change in the resonance properties of the sensor circuit may affect at least the quality factor of the sensor circuit and amplitude of the resonance of the sensor circuit.

In another embodiment, when the EMF modulator is configured to reflect EMF (FIG. 1B), the EMF modulator is operatively coupled to the pressure sensitive component to at least partially reflect an EMF generated by the sensor circuit. This reflection varies depending on the pressure applied to the pressure sensitive component. This difference originates from a change in a gap between the pressure sensitive component (diaphragm) and the sensor circuit (sensor tag). The gaps between the diaphragm and the sensor circuit are relatively large in the absence of applied pressure. The gap between the diaphragm and the sensor circuit is relatively small in the presence of applied pressure. The changes in the gaps alter the resonance properties of the sensor circuit. The smaller the gap (or gaps), the greater the change in resonance properties of the sensor circuit will be. The change in resonance properties may as affect at least the quality factor of the sensor circuit and amplitude of the resonance of the sensor circuit.

In one embodiment, the EMF absorber reduces the EMF of the sensor. The EMF absorber may be an electrically conductive film. The electrically conductive film may comprise a dielectric material. The efficiency of the radiation of the antenna may be decreased using EMF absorber. In some embodiments, the pressure sensitive component may be coupled to a portion of the RFID tag, such that the pressure sensitive component is disposed in close proximity to the EMF absorber, or in the region of the electrodes. The sensor comprises a protective layer disposed on the EMF absorber. The protective layer may be a solvent protective layer, optionally used to protect the sensor with an assembly of the EMF absorber from the external solvents/fluids under measurement condition. The protective layer may also protect the sensor from any adverse effect of the external fluids, such as shorting of the sensor electrode in high ionic strengths solutions, or corrosion of metallic sensor electrode coil by forming a physical barrier to the fluid medium. The material of the protective layer may include but not limited to flexible dielectric materials, such as polymers or silicones. The protective layer is an overlayer that does not permit the direct contact of the fluid with the sensor.

A resonance circuit-based temperature independent pressure sensor system comprises a resonance sensor circuit, a pressure sensitive component disposed on the resonance sensor circuit, and an EMF modulator operatively coupled to the pressure sensitive component, and a processor. The sensor system may further comprise an additional protective layer disposed on the EMF modulator. In one or more embodiments, the resonance based sensor system comprises an RFID tag. The term ‘operatively coupled’ refers to a connection, which may be a wired connection or may be a wireless connection. For example, the processor may be coupled to the sensor by a wired connection or a wireless connection. The processor is coupled to the sensor, wherein the processor generates a multivariate analysis of the sensor response pattern with a change in an environmental pressure of the sensor system. In one embodiment, multivariable or multivariate signal transduction is performed on the multiple response signals using multivariate analysis tools to construct a multivariate sensor response pattern.

In some embodiments, the temperature independent pressure sensor may be used in a detection system. The detection system may also comprise an associated display device, such as a monitor, for displaying the electrical signal representative of a pressure change.

The temperature independent pressure sensor may be used in a bioprocess component. The bioprocess component may comprise fluid-medium. In operation, the sensor may provide a desired quantitative response of pressure of the fluid present in the bioprocess component. The bioprocess component may comprise one or more of a storage bags, a transfer line, a filter, a connector, a valve, a pump, a centrifuge, a separation column, a biological hood, a chemical hood, or a bioreactor. The sensor may be sterilizable via UV radiation or any known method in the art, or in a specific embodiment, the sensor may be gamma-radiation sterilizable. The gamma-radiation sterilizable sensor may have a memory chip that is a read-write chip made with a ferroelectric random access memory chip. The gamma-radiation sterilizable sensor may have a memory chip that is a read-only chip made with a surface-acoustic wave chip.

In one embodiment, the sensor system comprises a pick-up coil, which is in operative association with the sensor to receive signals from the sensor. In some embodiments, the pick-up coil may be disposed on the sensor. In some embodiments, the sensor and the pick-up coil are co-located on a support in an appropriate geometrical arrangement. A fixing element, such as an adhesive, may be employed for fixing the pick-up coil in operative proximity to the sensor. The pick-up coil may employ a connector to provide electrical connection to the pickup coil. For example, the connector may include standard electronic connectors, such as gold-plated pins. The pick-up coil may be attached to the support in different ways. For example, the pick-up coil may be attached to the support using an adhesive, or by molding the pick-up coil with the support, or by fastening the pick-up coil to the support using screws. Alternatively, holders may be provided in the support such that the pick-up coil may rest on the holders in the support.

The pick-up coil may be disposable or re-usable, and may be used for transmitting and receiving the radio frequency signals. The pick-up coil may also be pre-calibrated, and may be in a physical contact with the sensor. In one example, the pick-up coil may be placed on a support, which is directly or indirectly coupled to the sensor.

The pick-up coil may either be fabricated or commercially available. In embodiments where the pick-up coil is fabricated, the pick-up coil may be fabricated employing standard fabrication techniques such as lithography, masking, forming a metal wire in a loop form, or integrated circuit manufacturing processing. For example, the pick-up coil may be fabricated using photolithographic etching of copper-clad laminates, or coiling of copper wire on a form.

In one embodiment, the sensor and the pick-up coil may be fabricated on a single dielectric substrate. In this embodiment, the mutual inductance between the sensor and the pick-up coil substantially remains the same, thereby facilitating pre-calibration of the sensor prior to disposing this supported geometrical arrangement into a single use component.

In some embodiments, the sensor may be pre-calibrated before positioning the sensor in bioprocess components. In certain embodiments, the sensor is adapted to be removed from the bioprocess components for additional recalibration or validation. The sensor may be re-calibrated during or after the operation in the bioprocess components. In one embodiment, in post recalibration, the sensor may be installed back in the device for monitoring of the process. However, in another embodiment, where the sensor is employed in a single use component, it may not be desired to re-install the sensor in the component once the sensor is removed. Therefore, the sensor may be disposable or re-usable. The sensor may be employed to facilitate monitoring and control for in-line manufacturing.

The multivariate analysis of the sensor response pattern identifiably separates patterns associated with the change in temperature and the change in pressure. The fluctuations in environmental temperature may also affect the impedance of the resonance sensor circuit. However, the effects of temperature and pressure may be quantitatively separated after the multivariate analysis of the response of the sensor. The complex impedance spectra of the resonance sensor circuit may be measured by selective quantitation of the pressure in the presence of variable temperature using the sensor.

A method of making a temperature independent pressure sensor comprises providing a resonance sensor circuit, disposing a pressure sensitive component on the resonance sensor circuit, and disposing an EMF modulator on the pressure sensitive component. The resonance sensor circuit, pressure sensitive component, and EMF modulator may be coupled together using a lamination process to form the sensor. Examples of such lamination processes are described in U.S. patent application Ser. No. 12/447,031 entitled “System for assembling and utilizing sensors in containers”, which is incorporated herein by reference.

Embodiments of method for making a temperature independent pressure sensor system comprises providing a resonance sensor circuit, disposing a pressure sensitive component on the resonance sensor circuit, and disposing an EMF modulator with the pressure sensitive component, and operatively coupling a processor that generates a multivariate analysis of sensor response pattern.

In certain embodiments, a method of measuring pressure changes in an environment, independent of temperature, comprises collecting complex impedance data from the sensor, applying a multivariate analysis to a plurality of resonance parameters, and quantifying any change in pressure that is independent of any change in temperature based at least in part on the multivariate analysis. Examples of such multivariate analyses are described in U.S. patent application Ser. No. 12/118,950 entitled “Methods and systems for calibration of RFID sensors”, which is incorporated herein by reference.

For selectively measuring pressure change, the sensor system may be disposed in contact with a fluid medium. The fluid medium may comprise a liquid medium or a gaseous medium. After contacting the sensor with the fluid medium, the sensor may be used to quantitate the effects of variable pressures by measuring several resonance parameters of the resonance sensor circuit. The sensor may be calibrated before the multivariate analysis. For multivariate analysis, the values may be stored in a memory chip of the resonance sensor circuit, with respect to the variable temperature and pressure. The multivariate sensor response pattern, reflecting the change in pressure in the presence of variable temperatures, is determined independent of a temperature. The multivariate analysis comprises identifying one or more sensor response patterns. While applying multivariate analysis to a plurality of resonance parameters, at least two of the resonance parameters are measured and calculated to generate the final response pattern.

Referring now to FIG. 1A and FIG. 1B, two different embodiments of a radio frequency based pressure sensor 10 are illustrated. The pressure sensor 10 employs a RFID tag 12, a pressure sensitive component 14, and an EMF modulator 16. In the embodiment of FIG. 1A, the pressure sensitive component is a membrane 14. In the embodiment of FIG. 1B, the pressure sensitive component is a diaphragm 18. Further, the RFID tag 12 comprises an associated EMF. The pressure sensitive component, such as the membrane 14 or the diaphragm 18, is disposed on the RFID tag 12. In one embodiment, the pressure sensitive component may be directly deposited on the RFID tag. In an alternate embodiment, the pressure sensitive component may be deposited on a substrate, and the substrate may be deposited directly on the RFID tag. One or more intervening layers may be present in between the RFID tag and the pressure sensitive component. The EMF modulator 16 is operatively coupled to the pressure sensitive component.

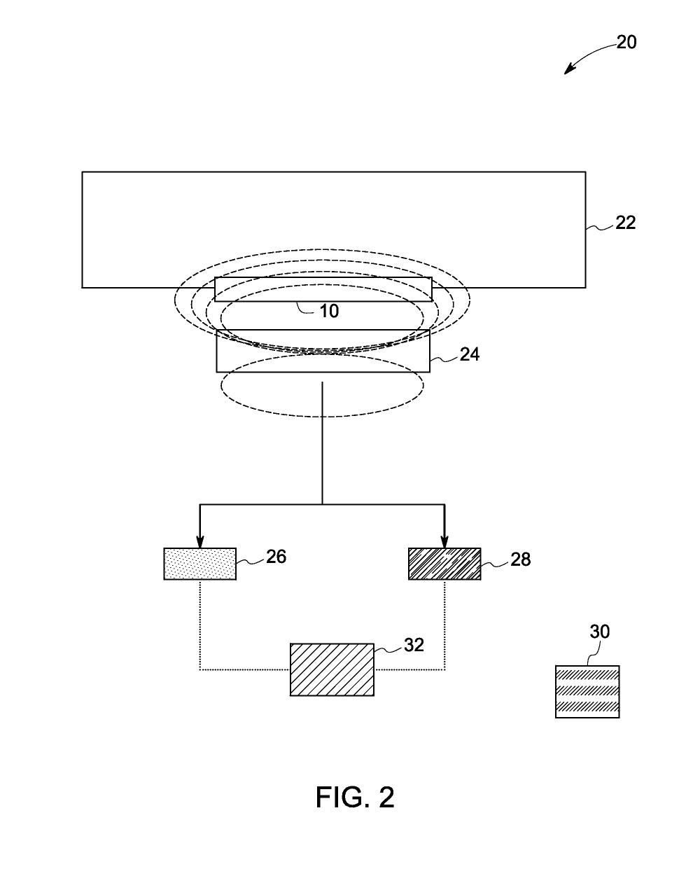

FIG. 2 illustrates a sensor system 20. A bioprocess component 22 employs a radio frequency based pressure sensor 10, and a pick-up coil 24. The pick-up coil 24 is directly or indirectly coupled to the sensor 10. The pick-up coil is further coupled to a network analyzer or a RFID reader or writer 26. In the illustrated embodiment, the RFID tag of the sensor 10 comprises an integrated circuit and an antenna. Further, the antenna of the RFID tag of the sensor 10 may generate an EMF. Upon coupling of the sensor with a pickup coil, the EMF is generated in the sensor antenna and is affected by the dielectric property of the pressure sensitive component. A pressure-induced dimensional change of the pressure sensitive component affects impedance, which may be analyzed by the network analyzer 26.

The total complex impedance of the sensor is measured using a network analyzer 26, while the digital information from the memory chip is read with a digital writer/reader 28. Impedance measurements are performed, for example, using a multiplexer. In some embodiments, a processor 30 is present in the system to generate a multivariate sensor response pattern. In some embodiments, a data acquisition and control unit 32 may be present in combination with the processor. For example, the processor 30 may acquire the sensor data and the calibration data from the data acquisition and control unit 32 to generate the multivariate sensor response pattern. Alternatively, the processor may be present at the user end, and configured to receive raw or semi-processed data over the Internet, for example, to generate the multivariate sensor response pattern.

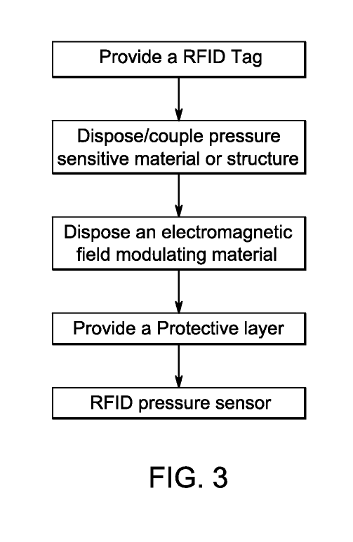

In one embodiment, a process for making a sensor system by assembling each component is generally shown in FIG. 3. The method of making the sensor system comprises the steps of providing a RFID tag, disposing a pressure sensitive component on the RFID tag using a silicone adhesive, followed by coupling of an EMF modulator to the pressure sensitive component using silicone adhesive. A protective layer of silicone may further be disposed on the EMF modulator to complete the making of sensor.

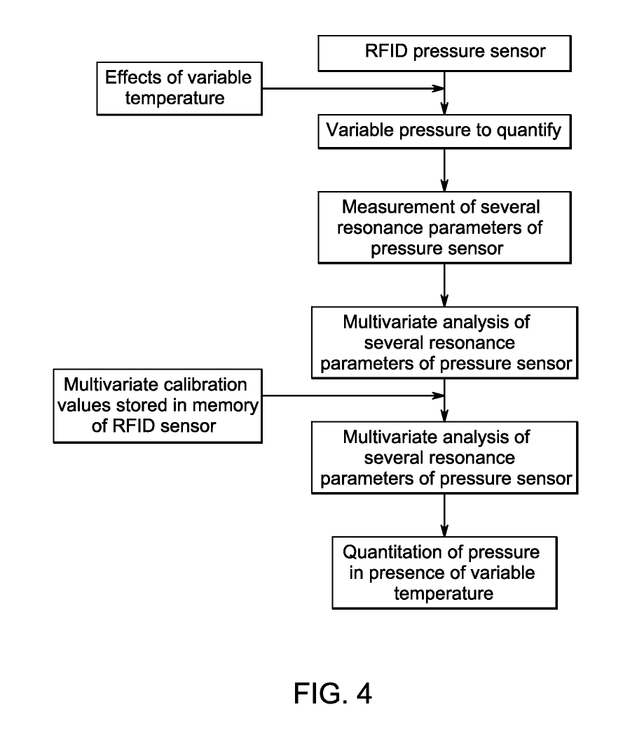

A method of measuring temperature independent pressure change of a material is generally shown in FIG. 4. The measurement comprises the steps of quantifying variable pressure in presence of variable temperature with the sensor, wherein the sensor comprises at least one RFID sensor circuit. The sensor further measures impedance response of several resonance parameters of the resonance sensor circuit, and determining a multivariate response pattern of the sensor by performing a principal component analysis (PCA) of the impedance response. The sensor is calibrated for multivariate response pattern, and multivariate calibration values form a model that is stored in a memory chip of the RFID sensor. The multivariate actual values and multivariate calibrated values are compared and finally determine the pressure in presence of variable temperature. Therefore, the multivariate sensor response pattern identifiably separates the change in pressure from the change in temperature.

The simultaneous quantitation of pressure and temperature using a single sensor, or the correction of pressure measurements for temperature variability using a single sensor, is possible at least in part because the environmental conditions (e.g. temperature and pressure) produce significant independent effects on the different components of the sensor circuit. The multivariable response of the sensor, followed by multivariate analysis of the response, serve in part to separate these effects. The multivariable response of the sensor may comprise the full complex impedance spectra of sensor and/or several individually measured properties Fp, Zp, Fz, F1 and F2. These properties comprise the frequency of the maximum of the real part of the complex impedance (Fp, resonance peak position), magnitude of the real part of the complex impedance (Zp, peak height), zero-reactance frequency (Fz, frequency at which the imaginary portion of impedance is zero), resonant frequency of the imaginary part of the complex impedance (F1), and antiresonant frequency of the imaginary part of the complex impedance (F2), signal magnitude (Z1) at the resonant frequency of the imaginary part of the complex impedance (F1), and signal magnitude (Z2) at the antiresonant frequency of the imaginary part of the complex impedance (F2). Other parameters may be measured using the entire complex impedance spectra, for example, quality factor of resonance, phase angle, and magnitude of impedance. Examples of such multivariable response parameters are described in U.S. patent application Ser. No. 12/118,950 entitled “Methods and systems for calibration of RFID sensors”, which is incorporated herein by reference.

### Example 1

Measurements of the complex impedance of RFID pressure sensors were performed with a network analyzer (Model E5062A, Agilent Technologies, Inc. Santa Clara, Calif.) under computer control using Lab VIEW. The network analyzer was used to scan the frequencies over the range of interest (typically centered at ˜13 MHz with a scan range of ˜10 MHz) and to collect the complex impedance response from the RFID pressure sensor. The collected complex impedance data was analyzed using Excel (MicroSoft Inc. Seattle, Wash.) or KaleidaGraph (Synergy Software, Reading, Pa.) and PLS_Toolbox (Eigenvector Research, Inc., Manson, Wash.) operated with Matlab (The Mathworks Inc., Natick, Mass.).

For quantitation of pressure with a single sensor over a varied temperature range, a temperature range of 10° C.-60° C. was selected. The pressure was quantitated using multivariate analysis of data acquired from RFID based sensor. A 9 mm Tag Sys RFID tag was adapted for sensing of pressure by attaching the RFID tag onto a wall of a plastic cap with an adhesive. A flexible membrane comprised of closed cell foam was disposed on the tag and attached to the tag with an adhesive. Metal foil was then adhered to the closed cell foam as an EMF modulator. An entire sensor-sandwich was formed with a plastic cap, a RFID tag, closed cell foam, and metal foil. The sensor-sandwich was then coated with silicone as a protective layer. Air pressure was applied that translated through the system to the deionized water present in the plastic cap of the sensor. A pressure transducer was present in line with the sensor for continuous pressure monitoring. A LabVIEW program controlled the air pressure of the system and collected data from the primary reference (commercial pressure transducer) and RFID based sensor. The pressurized cap resided in a bioprocess chamber where the temperature was controlled in a range from about 10° C. to 60° C.

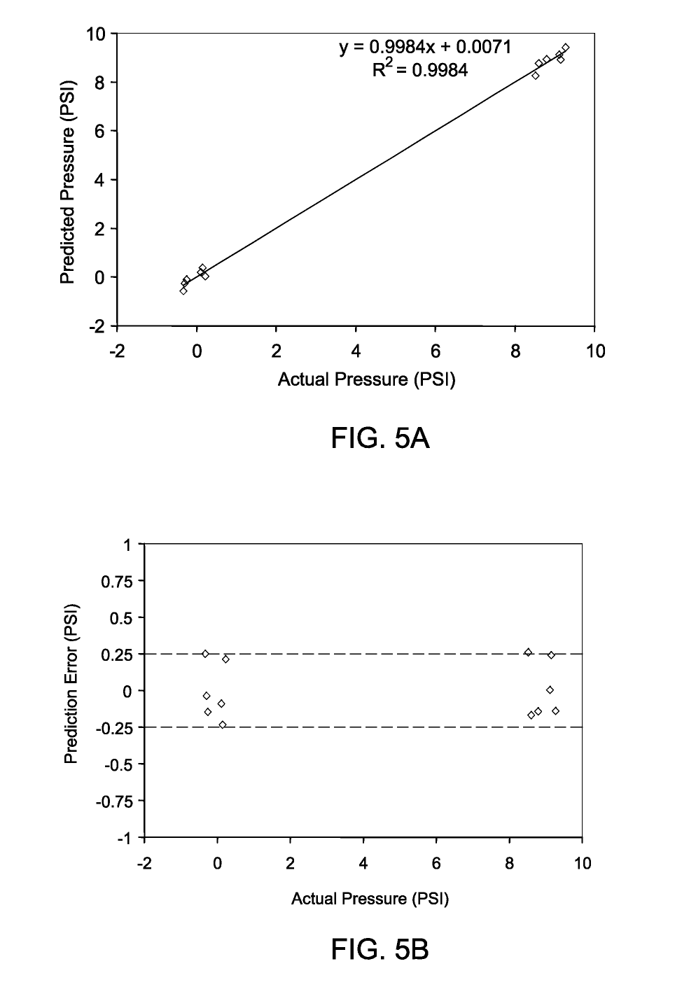

The sensor system was subjected to an initial run under varied pressure in a range from about 0 psi to 10 psi over temperatures of 10° C., 35° C., and 60° C. for 500 hours. FIG. 5A shows the sensor response pattern of a change in pressure by measuring the actual pressure vs. predicted pressure, and FIG. 5B shows the error distribution generated using a sensor by measuring the actual pressure vs. the residual pressure in the temperature independent model with a prediction of error within a range of ±0.25 psi. As a result, the pressure sensor was able to quantify pressure within acceptable margins of error.

### Example 2

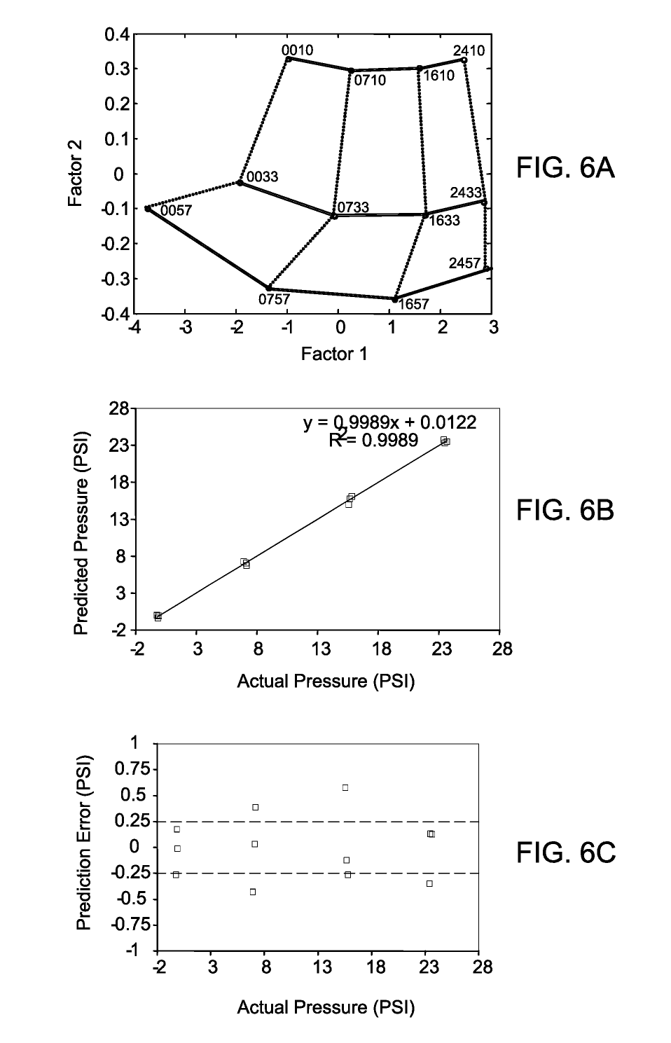

A similar experiment was performed in which the sensor was subjected to four different pressures (0 psi, 7 psi, 16 psi, and 24 psi) over the temperatures of about 10° C., 33° C., and 57° C. FIG. 6A shows a multivariate response of the sensor, using principal component analysis (PCA) where the sensor was subjected to four different pressures, such as, 0 psi, 7 psi, 16 psi, and 24 psi and three temperatures of 10° C., 33° C., and 57° C. The PCA plot of the first two principal components was related to the simultaneous changes in the pressure and the temperature of the fluid. Using these two principal components as inputs, FIG. 6B shows the plot for a sensor response pattern generated by measuring actual pressure vs. predicted pressure, and FIG. 6C shows the error distribution generated using the sensor by measuring actual pressure vs. the residual for the temperature independent model. As a result, the pressure sensor was able to quantify pressure at different temperatures of the sensor.

While only certain features of the invention have been illustrated and described herein, many modifications and changes will occur to those skilled in the art. It is, therefore, to be understood that the appended claims are intended to cover all such modifications and changes as fall within the scope of the invention.

1. A resonance circuit-based temperature independent pressure sensor, comprising:
a resonance sensor circuit;
a pressure sensitive component disposed on the resonance sensor circuit; and
an electromagnetic field modulator operatively coupled to the pressure sensitive component to at least partially modulate an electromagnetic field generated by the sensor circuit.

2. The sensor of claim 1, wherein the resonance sensor circuit is an inductor-capacitor-resistor circuit.

3. The sensor of claim 1, wherein the resonance sensor circuit comprises a radio frequency identification circuit.

4. The sensor of claim 3, wherein the radio frequency identification circuit comprises a radio frequency identification tag.

5. The sensor of claim 1, wherein the electromagnetic field modulator is configured to absorb electromagnetic field.

6. The sensor of claim 1, wherein the electromagnetic field modulator is configured to reflect electromagnetic field.

7. The sensor of claim 1, further comprising a protective layer disposed on the electromagnetic field modulator.

8. The sensor of claim 7, wherein the protective layer comprises flexible dielectric materials comprising polymers or silicones.

9. The sensor of claim 1, wherein the pressure sensitive component comprises a flexible membrane, a diaphragm, a mechanical spring, or a combination thereof.

10. The sensor of claim 1, wherein a structure of the pressure sensitive component is selected from a spherical shape, a dome shape, a cubical shape, a flat sheet, or a combination thereof.

11. The sensor of claim 1, wherein a material of the pressure sensitive component is selected from a metal, a polymer, a foam, a dielectric material, or a combination thereof.

12. The sensor of claim 1, wherein the pressure sensitive component is impregnated with an electrically conductive material.

13. The sensor of claim 12, wherein the electrically conductive material comprises carbon black particles, metal nanoparticles, metal microparticles, carbon nanotubes, graphene sheets, or combinations thereof.

14. The sensor of claim 1, wherein the electromagnetic field modulator comprises an electrically conductive film.

15. The sensor of claim 1, wherein the electromagnetic field modulator comprises one or more layers.

16. The sensor of claim 15, wherein the electromagnetic field modulator comprises a stack of layers, wherein two or more of the layers comprise different materials.

17. The sensor of claim 1, wherein the sensor is capable of operating within an electromagnetic spectrum having a frequency in a range from about 100 kHz to 20 GHz.

18. The sensor of claim 1, wherein the sensor is incorporated into a bioprocess component.

19. A resonance circuit-based temperature independent pressure sensor system, comprising:
a resonant sensor circuit;
a pressure sensitive component disposed on the resonance sensor circuit; and
an electromagnetic field modulator operatively coupled to the pressure sensitive component to at least partially modulate an electromagnetic field generated by the sensor circuit to produce a sensor response pattern; and
a processor that generates a multivariate analysis of the sensor response pattern that is based, at least in part, on the sensor response pattern.

20. The sensor system of claim 19, wherein the resonant sensor circuit comprises a radio frequency identification circuit.

21. The sensor system of claim 19, wherein the processor receives the sensor response pattern wirelessly.

22. A method of measuring temperature independent pressure change of a sample, comprising:
collecting impedance data using a sensor comprising a resonance sensor circuit, a pressure sensitive component and an electromagnetic field modulator;
applying a multivariate analysis to a plurality of resonance parameters, at least two of which are based on the collected impedance data; and
quantifying any change in pressure that is independent of any change in temperature based at least in part on the multivariate analysis.

23. The method of claim 22, wherein the multivariate analysis comprises identifying one or more sensor response patterns.

24. The method of claim 22, wherein at least one of the resonance parameters is measured and at least one of the resonance parameters is calculated.
